(19) United States
(12) Patent Application Publication
(10) Pub. No.: US 2010/0206281 A1
(43) Pub. Date: Aug. 19, 2010

(54) TRIGGER MOUNTING ASSEMBLY AND METHOD FOR PAINTBALL GUN

(75) Inventors: Daniel A. Kanitz, Loyalhanna, PA (US); Edward S. Telford, Loyalhanna, PA (US)

Correspondence Address: SIMPLE IP LAW, P.C., 9600 SW OAK STREET., SUITE 525, TIGARD, OR, 97223, US

(73) Assignee: SMART PARTS, INC., Latrobe, PA (US)

(21) Appl. No.: 11/673,116

(22) Filed: Feb. 9, 2007

(51) Int. Cl. F41A 19/10; B23P 11/00

(52) U.S. Cl. 124/31; 29/525.11

(57) ABSTRACT

A trigger assembly for a paintball gun preferably includes a trigger having a bearing assembly arranged snugly within a bearing receptacle of the trigger to provide a trigger pivot. The bearing assembly can include a pin receptacle on each side of the bearing assembly to receive a pair of trigger pins in a mating relationship. The trigger assembly can be mounted in a paintball gun by arranging the trigger and bearing assembly in a trigger groove of a grip frame of the paintball gun and aligning the pin receptacles with pin holes formed through the wall of the grip frame on opposite sides of the trigger groove. The pins can then be inserted through the pin holes into firm contact with sidewalls of the pin receptacle(s). Each of the pins can be independently adjusted to arrange the trigger in a desired lateral location within the trigger groove. By providing a firm engagement between the pins and the pin receptacles of the bearing assembly and a snug fit between the bearing assembly and the bearing receptacle of the trigger, lateral stability can be imparted to the trigger throughout its entire course of travel.

### FIELD OF THE INVENTION

This invention relates generally to triggers for pneumatic paintball guns (“markers”) or other pneumatic guns. More specifically, this invention relates to a method and apparatus for mounting a trigger in a pneumatic gun.

### BACKGROUND OF THE INVENTION

Paintball is a fast-paced game, and players must be able to fire quickly and accurately to be victorious. Until recently, paintball was played with purely mechanically-operated pneumatic markers. With the introduction of electronic paintball guns, however, a new age in paintball technology was born. Along with electronic control came the ability to precisely control the timing of gun operations. Precise electronic timing enabled much higher firing rates than previously considered possible. The extremely light triggers made possible by use of a trigger-actuated microswitch made it possible for users to easily reach high firing rates even in pure semi-automatic mode.

Unfortunately, conventional methods of mounting triggers in paintball guns, and particularly in electro-pneumatic paintball guns capable of high rates of fire, generally result in some degree of side to side trigger movement during operation of the trigger. Side to side trigger movement (or “play”) is undesirable and gives the trigger a loose or sloppy feel.

FIG. 1 is a somewhat schematic exploded perspective illustration of a representative conventional trigger mounting system in an electronic paintball gun. Referring to FIG. 1, the trigger mounting system consists of a trigger 15 having a pin receptacle 16 at a trigger pivot point, a grip frame 10 having pin holes 12 arranged on opposing sides of a trigger groove 14, and a trigger pin 13. As shown, this conventional trigger pin 13 is a substantially cylindrical pin that slides through the pin holes 12 in the trigger frame 10 and the pin receptacle 16 in the trigger 15 to hold the trigger 15 in place within the trigger groove 14. The pin 16 provides a tight interference fit with the pin holes 12 in the grip frame 10 while providing a looser fit within the trigger pin receptacle 16. This permits easy pivoting of the trigger 15 about its pivot point.

Unfortunately, by providing a looser fit between the trigger pin and pin receptacle to enable easier trigger actuation for faster rates of fire, conventional mounting systems may also result in a sloppier feel with more side to side movement than is desirable. It would therefore be desirable to have a way to permit easy and rapid actuation of a trigger system while more effectively preventing side to side movement of the trigger. Accordingly, the industry would be benefited by a trigger assembly that is easy to fire at a rapid firing rate, yet provides a smooth and stable feel throughout the full trigger cycle.

### SUMMARY OF THE INVENTION

According to one aspect of this invention, an improved trigger mounting system includes a trigger having an opening (bearing receptacle) arranged at a pivot point of the trigger. One or more bearings (e.g., roller or ball bearings) are preferably arranged within the bearing receptacle. Each bearing is preferably substantially cylindrical in shape with an outer diameter configured to fit tightly within the bearing receptacle (such as through a press or interference fit). Each bearing also preferably has an opening (pin receptacle) of its own formed in a central portion thereof.

A pair of opposing trigger set screws (or pins) are preferably provided and threaded (or inserted) through screw (pin) holes in the grip frame to secure the trigger within a trigger groove of the grip frame. Each of the trigger set screws preferably includes a tapered inward end (e.g., conically-shaped or rounded) that is configured to matingly engage within the pin receptacle of a corresponding one of the bearing receptacles at a location along its tapered surface. A head arranged on the outward end of each set screw, opposite the tapered end, preferably includes a means for tightening the set screw into the grip frame. This can, for instance, be an Allen wrench opening or a conventional flat or Phillips screw head. The outer surface of the trigger set screws can be threaded to engage corresponding threads of the set screw receptacle in the grip frame.

A method of mounting a trigger preferably proceeds by arranging one or more pivot bearings, each having a pin receptacle, within a pivot opening in the trigger. The trigger is then arranged within a trigger groove in the grip frame and opposing trigger pins (or set screws) are inserted through opposing pin (screw) holes in the grip frame until they contact the sides of the pin receptacle(s) in opposing sides of the pivot bearing(s). The trigger pins are preferably secured firmly within the pin receptacles in tight contact with the pivot bearings to prevent side to side movement of the trigger. Each trigger pin is preferably independently adjustable to permit arrangement of the trigger within a desired location in the trigger groove of the grip frame and to permit fine-tuned adjustment of the trigger feel.

Once arranged in the paintball gun, the trigger is preferably able to pivot smoothly and stably on the bearings throughout the entire trigger stroke, without any appreciable side to side movement. The trigger according to this invention is thereby able to avoid the sloppy feel that can be experienced in conventional trigger assemblies.

Various other embodiments are also contemplated as being within the scope of the present invention and will be readily apparent to those of skill in the art based on the following detailed description.

### BRIEF SUMMARY OF THE DRAWINGS

The foregoing and additional objects and advantages of the present invention will become more readily apparent through the following detailed description, made with reference to the accompanying drawings, in which:

FIG. 1 is a somewhat schematic exploded perspective view of a conventional paintball gun grip frame and trigger assembly;

FIG. 2 is a somewhat schematic perspective view of a paintball gun grip frame having an improved trigger assembly, according to one embodiment of the present invention;

FIG. 3 is a somewhat schematic perspective view of the trigger assembly of FIG. 2;

FIG. 4 is a somewhat schematic perspective view of pivot bearings of the trigger assembly of FIG. 3;

FIG. 5 is a somewhat schematic perspective view of trigger pins of the trigger assembly of FIG. 3; and

FIG. 6 is a somewhat schematic cross-sectional front view of the paintball gun grip frame with the improved trigger assembly of FIG. 1.

### DETAILED DESCRIPTION

Various preferred aspects of the present invention will now be described in detail with reference to the accompanying figures. It should be noted, however, that the following description is provided by way of example only and not of limitation, and that many other implementations and embodiments of the present invention will be readily apparent to those skilled in the art based on the disclosure herein. The scope of the invention is therefore not limited to the particular embodiments described herein.

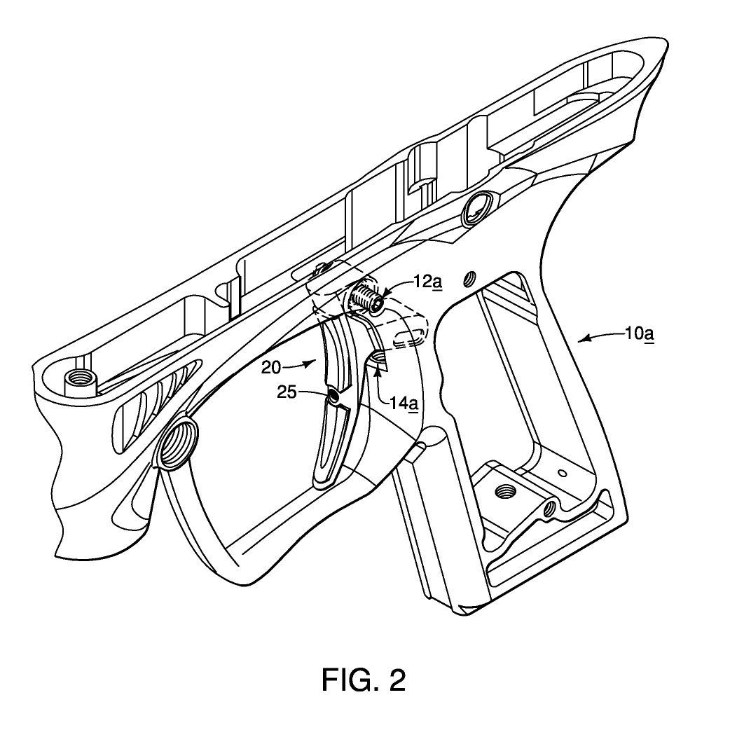

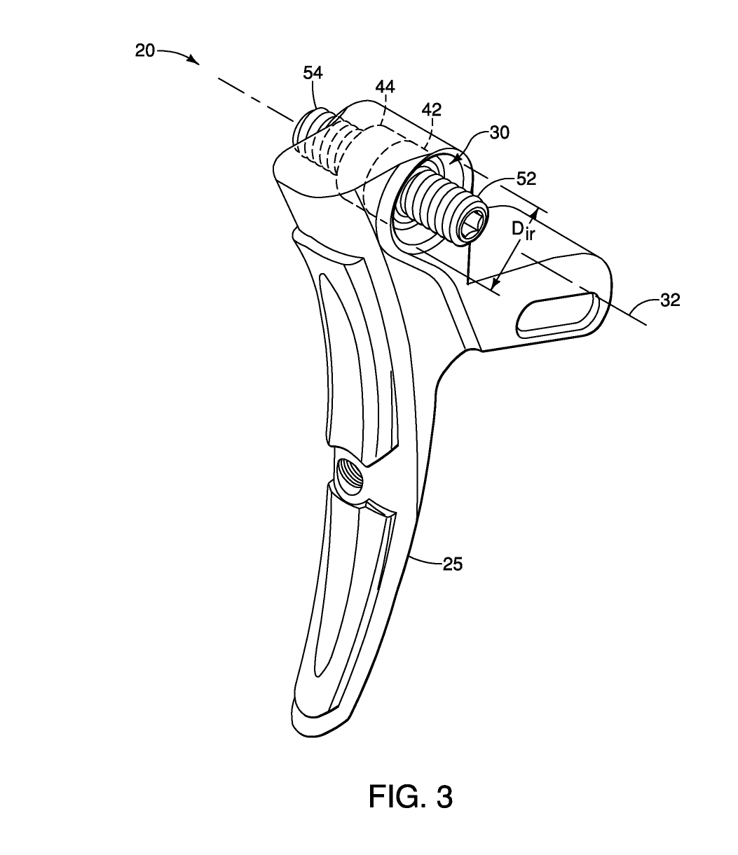

FIG. 2 shows a paintball gun grip frame 10a having an improved trigger assembly 20 mounted therein, while FIG. 3 illustrates the trigger assembly 20 removed from the paintball gun grip frame 10a of FIG. 2. Referring to FIGS. 2 and 3, in one embodiment constructed according to principles of the present invention, an improved trigger assembly 20 is mounted in a paintball gun grip frame 10a in a manner that provides a smooth and stable pivoting motion throughout the entire course of trigger travel.

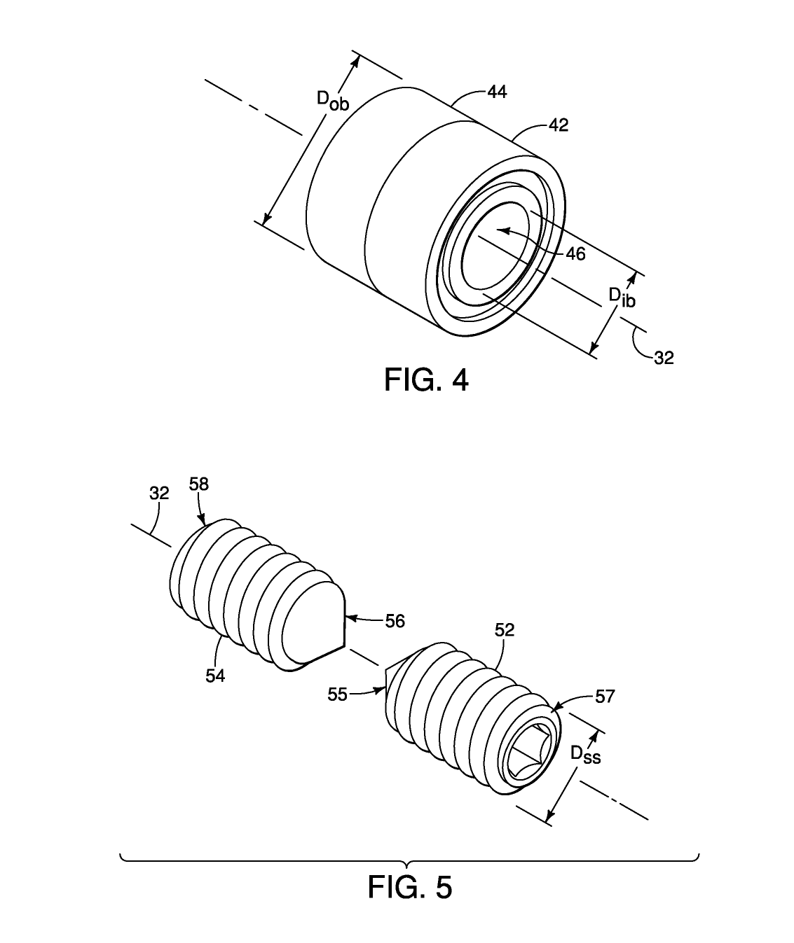

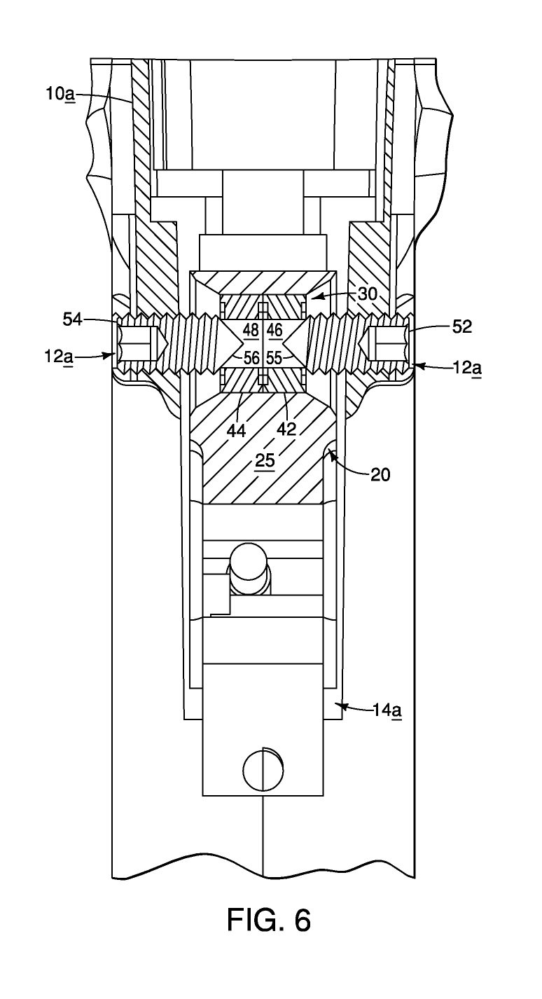

According to this embodiment, a trigger assembly 20 preferably includes a trigger 25, one or more bearings 42, 44 (e.g., roller or ball bearings), and a pair of opposing trigger set screws (or pins) 52, 54. The trigger 25 preferably includes a substantially cylindrical bearing receptacle 30 arranged through the trigger 25 to provide a trigger pivot point (about axis 32). Referring additionally to FIG. 4, each of the bearings 42, 44 can be formed or machined having a substantially cylindrical outer shape with an outside diameter D_{ob} configured to fit snugly within the bearing receptacle 30 of the trigger 25, such as through a press fit or interference fit. The outside diameter D_{ob} of the bearings 42, 44 should therefore be just slightly larger than the inside diameter Dᵢᵣ of the trigger bearing receptacle 30 to provide a secure press fit (or interference fit). A substantially cylindrical opening can be arranged through a center of each of the bearings to provide a pin receptacle 46, 48 (see also FIG. 6).

Referring additionally to FIG. 5, the trigger set screws 52, 54 each preferably include a substantially cylindrical outer circumference that may be threaded to threadingly engage screw (pin) holes 12a in the grip frame 10a. An inwardly-facing end of each of the trigger set screws 52, 54 preferably comprises a tapered surface 55, 56, such as a substantially conically-shaped or rounded surface, that tapers inwardly from the outer circumference toward the center. This permits the set screws 52, 54 to contact an inner surface of the pin receptacles 46, 48 (or side of the bearings 42, 44) in at least three points along the tapered surface 55, 56. the An outwardly-facing end 57, 58 of each of the trigger set screws 52, 54 preferably provides a head that permits adjustment of the trigger set screw 52, 54 using a tool such as an Allen wrench or a Phillips or flat head screwdriver. The pin receptacles 46, 48 preferably have a diameter D_{ib} that is smaller than the diameter Dₛₛ of an outer circumference of the trigger set screw 52, 54 so that it will contact the set screw at a location along its tapered inward surface 55, 56.

FIG. 6 is a somewhat schematic cross-sectional front view of the paintball gun grip frame 10a with the improved trigger assembly 20 mounted therein. Referring to FIGS. 2-6, to install the trigger assembly 20, the bearings 42, 44 are preferably arranged tightly within the trigger bearing receptacle 30. The trigger 25 is then placed within the trigger groove 14a in the grip frame 10a such that the pin receptacles 46, 48 in the bearings 42, 44 are aligned with the screw (pin) holes 12a arranged through the grip frame 10a on opposing sides of the trigger groove 14a. The two trigger pins 52, 54 are then preferably threaded into the pin holes 12a on opposing sides of the trigger 25 until the tapered ends 55, 56 contact the inner surface of the pin receptacle 46, 48 of the respective bearing 42, 44. Each of the trigger pins 52, 54 can then be independently tightened until the trigger 25 is securely retained in its desired lateral position within the trigger groove 14a.

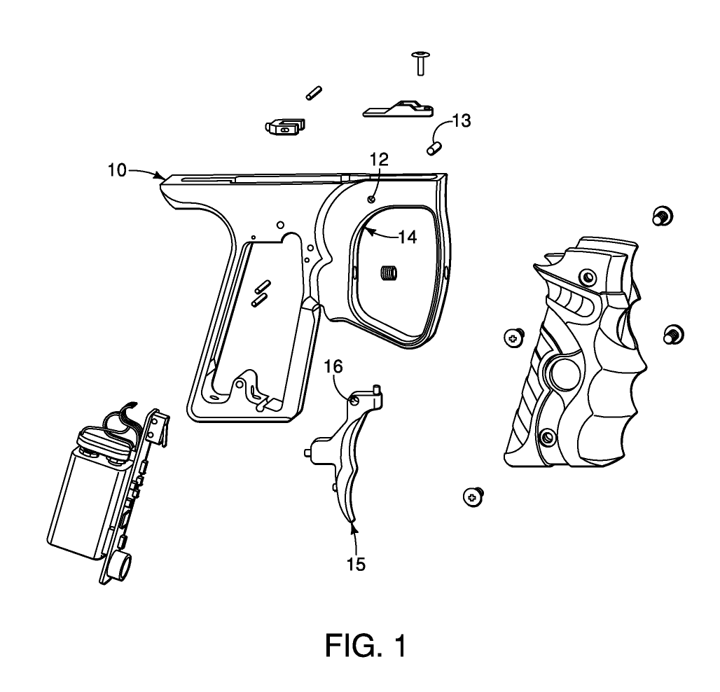

Unlike the conventional paintball gun trigger mounting system described earlier with reference to FIG. 1, the trigger mounting system and method of this invention permits the trigger to be mounted in a way that can substantially reduce or eliminate side to side (lateral) movement (or “play”) of the trigger. More particularly, as shown in FIG. 6, when the trigger assembly 20 is arranged in the grip frame 10a according to the principles of the present invention, the bearings 42, 44 preferably provide a snug or tight interference fit within the receptacle 30 of the trigger 25. The adjustable set screws 52, 54 further provide the ability to adjust and fine tune the trigger positioning and feel, while providing a tight fit within the pin receptacles 46, 48. The ball or roller bearings 42, 44 provide stable rotational movement of the trigger 25. In this manner, the trigger assembly 20 of the present invention provides a smooth and stable operation that substantially reduces or eliminates lateral instability of the trigger 25 during throughout the course of travel.

Having described and illustrated the principles of the invention with respect to various preferred embodiments thereof, it should be apparent that the invention can be modified in arrangement and detail without departing from such principles. Numerous modifications and variations to the foregoing embodiments are possible and will be apparent to those skilled in the art. For example, the bearings could be arranged with protrusions that extend from the bearings into receptacles in the set pins or into the pin receptacles in the grip frame. The appended claims should therefore be interpreted to cover all such modifications and variations.

What is claimed is:

1. A trigger assembly for a paintball gun, said trigger assembly comprising:
a trigger;
a bearing assembly comprising one or more bearings arranged within the trigger to provide a trigger pivot point; and
a pair of opposing set pins, wherein each set pin is configured to matingly engage one side of the bearing assembly.

2. A trigger assembly according to claim 1, wherein the trigger further comprises a bearing receptacle that receivingly engages the bearing assembly in a press fit.

3. A trigger assembly according to claim 1, wherein the bearing assembly comprises one or more pin receptacles that receive ends of the set pins in a mating relationship on opposite sides of the bearing assembly.

4. A trigger assembly according to claim 3, wherein each of the set pins comprises a tapered end that seats within one of the pin receptacles.

5. A trigger assembly according to claim 4, wherein the tapered ends of the set pins are substantially conically-shaped or rounded.

6. A trigger assembly according to claim 1, wherein the set pins are interchangeable set screws that threadingly engage pin holes in a grip frame of a paintball gun.

7. A trigger assembly according to claim 1, wherein the bearing assembly is formed integrally with the trigger.

8. A trigger assembly according to claim 1, wherein the bearing assembly comprises a pair of opposing protrusions configured to matingly engage a receptacle in a corresponding one of the set pins.

9. A trigger assembly according to claim 1, wherein each set pin contacts the bearing assembly in at least three contact points to provide a stable connection between a paintball gun and the trigger assembly.

10. A trigger assembly according to claim 1, wherein each set pin is independently adjustable to enable adjustment of a lateral position of the trigger within a grip frame of the paintball gun.

11. A paintball gun having an improved trigger assembly, said paintball gun comprising:
a grip frame comprising a trigger groove and a pair of pin holes arranged through the grip frame on opposing sides of the trigger groove;
a trigger arranged in the trigger groove;
a bearing assembly comprising one or more bearings arranged in the trigger to provide a trigger pivot point, wherein said bearing assembly is aligned with the pin holes in the grip frame; and
a pair of pins arranged through the pin holes of the grip frame and in a mating relationship with the bearing assembly.

12. A paintball gun according to claim 10, wherein the bearing assembly comprises one or more pin receptacles, and wherein the ends of the pins are receivingly engaged within the one or more pin receptacles on opposing sides of the bearing assembly.

13. A paintball gun according to claim 12, wherein each pin has a tapered or rounded end configured to matingly engage within the one or more pin receptacles.

14. A paintball gun according to claim 13, wherein the tapered end is substantially conically-shaped.

15. A paintball gun according to claim 11, wherein the pins are each configured to threadingly engage one or more of the pin holes in the grip frame.

16. A method of mounting a trigger assembly in a paintball gun, said method comprising:
arranging a bearing assembly in a trigger to provide a pivot point for the trigger;
placing the trigger and bearing assembly in a trigger groove of a grip frame of a paintball gun with the bearing assembly aligned with pin holes formed through the grip frame on opposing sides of the trigger groove; and
inserting a pair of pins through the pin holes, wherein the pins engage opposing sides of the bearing assembly in a mating relationship.

17. A method according to claim 16, wherein the pins are threaded set screws and wherein inserting the pins through the pin holes comprises threading each pin through a respective pin hole into contact with a respective side of the bearing assembly.

18. A method according to claim 16, wherein each pin comprises a tapered or rounded end, wherein the bearing assembly comprises one or more pin receptacles, and wherein the tapered or rounded end of each pin is matingly arranged within a corresponding one of the one or more pin receptacles of the bearing assembly.

19. A method according to claim 18, wherein the pin ends engage a corresponding one of the one or more pin receptacles in at least three contact points.

20. A method according to claim 16, further comprising independently adjusting each of the pins to position the trigger in a desired lateral location within the trigger groove.
